(19) United States
(12) Patent Application Publication
(10) Pub. No.: US 2023/0238571 A1
(43) Pub. Date: Jul. 27, 2023

(54) Conducting Polymer/Inorganic Hybrid Solid-State Electrolytes, Lithium Batteries Containing Same, and Production Processes

(71) Applicant: Global Graphene Group, Inc., Dayton, OH (US)

(72) Inventors: Aruna Zhamu, Springboro, OH (US); Bor Z. Jang, Centerville, OH (US)

(73) Assignee: Global Graphene Group, Inc., Dayton, OH (US)

(21) Appl. No.: 17/649,149

(22) Filed: Jan. 27, 2022

(51) Int. Cl. H01M 10/056; H01M 10/0525

(52) U.S. Cl. CPC H01M 10/056; H01M 10/0525; H01M 2300/0071; H01M 2300/0082; H01M 2004/028

(57) ABSTRACT

A hybrid solid electrolyte particulate for use in a rechargeable lithium battery cell, wherein said particulate comprises one or more than one inorganic solid electrolyte particles encapsulated by a shell of conducting polymer electrolyte wherein (i) the hybrid solid electrolyte particulate has a lithium-ion conductivity from 10⁻⁶ S/cm to 5×10⁻² S/cm and both the inorganic solid electrolyte and the conducting polymer electrolyte individually have a lithium-ion conductivity no less than 10⁻⁶ S/cm; (ii) the conducting polymer electrolyte has an electron conductivity no less than 10⁻⁶ S/cm; and (iii) the conducting polymer electrolyte-to-inorganic solid electrolyte ratio is from 1/100 to 100/1 or the conducting polymer electrolyte shell has a thickness from 1 nm to 10 μm. Also provided is a lithium-ion or lithium metal cell containing multiple hybrid solid electrolyte particulates in the anode and/or the cathode. Processes for producing hybrid solid electrolyte particulates are also disclosed.

### FIELD

The present disclosure provides a fire/flame-resistant hybrid electrolyte and lithium batteries (lithium-ion and lithium metal batteries) containing such an electrolyte. The electrolytes can be implemented in an anode (negative electrode) and/or a cathode (positive electrode) of a battery cell.

### BACKGROUND

Rechargeable lithium-ion (Li-ion) and lithium metal batteries (e.g., lithium-sulfur, lithium selenium, and Li metal-air batteries) are considered promising power sources for electric vehicle (EV), hybrid electric vehicle (HEV), and portable electronic devices, such as lap-top computers and mobile phones. Lithium as a metal element has the highest lithium storage capacity (3,861 mAh/g) compared to any other metal or metal-intercalated compound as an anode active material (except Li_{4,4}Si, which has a specific capacity of 4,200 mAh/g). Hence, in general, Li metal batteries (having a lithium metal anode) have a significantly higher energy density than lithium-ion batteries (having a graphite anode).

However, the liquid electrolytes used for all lithium-ion batteries and all lithium metal secondary batteries pose some safety concerns. Most of the organic liquid electrolytes can cause thermal runaway or explosion problems. To mitigate these risks, one can replace organic liquid electrolytes with inorganic solid electrolytes, which feature higher thermal stability and are not susceptible to leakage. This replacement affords high-energy-density all-solid-state batteries (ASSBs), which have attracted much attention, as exemplified by many recent attempts to use solid electrolytes in combination with high-voltage cathodes, high-capacity sulfur electrodes, and Li metal anodes for improved energy densities and safety.

Solid state electrolytes are commonly believed to be safe in terms of fire and explosion proof. Solid state electrolytes can be divided into organic (polymeric), inorganic, organic-inorganic composite electrolytes. However, the lithium-ion conductivity of well-known organic polymer solid state electrolytes, such as poly(ethylene oxide) (PEO), polypropylene oxide (PPO), poly(ethylene glycol) (PEG), and poly(acrylonitrile) (PAN), is typically low (<10⁻⁵ S/cm), although there are solid polymeric electrolytes that exhibit higher conductivity.

Although the inorganic solid-state electrolyte (e.g., garnet-type and metal sulfide-type) can exhibit a high conductivity (from 5×10⁻⁵ to 10⁻² S/cm), the interfacial impedance or resistance between the inorganic solid-state electrolyte and the electrode (cathode or anode) is high, often leading to unsatisfactory power densities. Further, the traditional inorganic ceramic electrolyte is very brittle and has poor film-forming ability and poor mechanical properties. Furthermore, many of these materials cannot be cost-effectively manufactured into a thin separator.

Among the various types of inorganic solid electrolytes (e.g., sulfide-, oxide-, hydride-, and halide-based) developed to date, the sulfide-based ones feature high conductivities and interface formability, and are therefore particularly well suited for ASSBs. In particular, sulfide electrolytes with Li₁₀GeP₂S₁₂, argyrodite, and Li₇P₃S₁₁-type crystal structures have high conductivities (>10⁻³ S/cm and some >10⁻² S/cm), comparable to those of liquid electrolytes. Sulfide electrolytes are easily deformed by pressing at room temperature, allowing one to form favorable electrode/electrolyte interfaces with high contact areas, and ensure sufficient ion conduction. However, processing of sulfide electrolyte-based electrodes and separators using the common slurry coating process can involve emission of undesirable chemical species (e.g., toxic hydrogen sulfide). Further, the volume changes of the electrode active materials during charge/discharge tend to induce local contact losses at the electrode/electrolyte interfaces in an ASSB.

Another serious drawback of implementing the inorganic solid electrolyte (ISE) in an electrode (anode or cathode) is the notion that it would normally take a high loading of the ISE particles (typically 30-60% by volume) to meet the two essential conditions: (i) the electrolyte should form a contiguous phase through which lithium ions can travel to reach individual particles of an electrode (anode or cathode) active material; and (ii) substantially each and every electrode active material particle (e.g., graphite or Si particles in the anode or lithium metal oxide particles in the cathode) should be in physical contact with this contiguous electrolyte phase. This implies that the proportion of the electrode active material responsible for the lithium-ion storage capability in an electrode would be reduced to less than 40-70%, leading to a significantly reduced energy density of the resulting battery cell. It is thus essential to minimize the amounts of the electrolyte and other non-active materials, such as conductive filler and binder, in an electrode.

The most series issue associated with certain solid-state electrolytes (e.g., sulfide solid-state electrolytes, SSEs) is the observation that these electrolytes have a narrow electrochemical stability window when compared with oxides and halides. Such a narrow electrochemical stability window is a major practical disadvantage of sulfide SSEs since the electrolyte should be stable over a wide range of lithium potentials between the anode chemical potential (0 eV/atom vs. Li/Li⁺) and the potential set by the cathode, which is near 4.0 eV/atom vs. Li/Li⁺ for some typical cathode active materials.

Hence, a general object of the present disclosure is to provide a safe, flame/fire-resistant, solid-state electrolyte system for a rechargeable lithium cell that overcomes most or all of the aforementioned issues. Desirably, the electrolyte is also compatible with existing battery production facilities. It is a further object of the present disclosure to provide an electrolyte that occupies a minimal proportion of the total volume of an electrode, yet still forms a contiguous phase in the electrode and is in physical contact with substantially all the electrode active material particles.

### SUMMARY

The present disclosure provides a hybrid solid electrolyte particulate for use in a rechargeable lithium battery cell, wherein said particulate comprises one or more than one inorganic solid electrolyte particles encapsulated by a shell of conducting polymer electrolyte wherein (i) the hybrid solid electrolyte particulate has a lithium-ion conductivity from 10⁻⁶ S/cm to 5×10⁻² S/cm and both the inorganic solid electrolyte and the conducting polymer electrolyte individually have a lithium-ion conductivity no less than 10⁻⁶ S/cm (typically from 10⁻⁴ to 10⁻³ S/cm); (ii) the conducting polymer electrolyte has an electron conductivity no less than 10⁻⁶ S/cm; and (iii) the conducting polymer electrolyte-to-inorganic solid electrolyte ratio is from 1/100 to 100/1 or the conducting polymer electrolyte shell has a thickness from 1 nm to 10 μm.

The encapsulating polymer shell preferably has a thickness from 1 nm to 10 μm (preferably from 2 nm to 2 μm, more preferably less than 1 μm, and most preferably less than 500 nm). In certain embodiments, the inorganic solid electrolyte material particles are preferably from 5 nm to 20 μm in diameter, more preferably from 20 nm to 10 μm, and most preferably smaller than 5 μm).

Preferably, the hybrid electrolyte particle has a lithium-ion conductivity from 10⁻⁵ S/cm to 5×10⁻² S/cm. Preferably, the polymer electrolyte alone (without the ISE) has a lithium-ion conductivity from 10⁻⁸ S/cm to 5×10⁻² S/cm, more typically from 10⁻⁶ S/cm to 10⁻² S/cm, more preferably greater than 10⁻⁵ S/cm, further more preferably greater than 10⁻⁴ S/cm, and most preferably greater than 10⁻³ S/cm. The conductivity measurement methods are well-known in the art. One can consolidate these materials into a thin film (e.g., having a thickness from 1 to 100 μm, preferably from 10 to 50 μm).

Also provided is a lithium-ion or lithium metal cell containing multiple hybrid solid electrolyte particulates in the anode and/or the cathode. The disclosure further provides an anode or a cathode that comprises the presently disclosed multiple hybrid solid electrolyte particulates or an electrolyte derived from the presently disclosed multiple hybrid solid electrolyte particulates.

In certain embodiments, the inorganic solid electrolyte material is selected from an oxide type, sulfide type (including, but not limited to, the thio-LISICON type, glass-type, glass ceramic-type, and argyrodite-type sulfide electrolyte), hydride type, halide type, borate type, phosphate type, lithium phosphorus oxynitride (LiPON), garnet-type, lithium superionic conductor (LISICON) type, sodium supertonic conductor (NASICON) type, or a combination thereof.

In certain embodiments, the conducting polymer electrolyte comprises a linear, branched, or network of crosslinked chains comprising chains of a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

In some preferred embodiments, the conducting polymer comprises a network of crosslinked chains comprising polyaniline, polypyrrole, or polythiophene chains.

In certain embodiments, the conducting polymer comprises a network of crosslinked chains comprising chains of a conjugate polymer and chains selected from polyethylene oxide, polypropylene oxide, pentaerythritol tetraacrylate, poly(ethylene glycol) diacrylate, poly(ethylene glycol) methyl ether acrylate, poly(ethylene glycol phenyl ether acrylate) (PEGPEA), ethoxylated trimethyl propyl triacrylate (ETPTA), or a combination thereof. These polymer chains, when combined with a conjugate polymer, provide a network polymer that is both ion-conducting and electron-conducting.

The conducting polymer electrolyte may further comprise a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, poly(alkylsiloxane), poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyacrylamide, a polyionic liquid, polymerized 1,3-dioxolane, polyepoxide ether, polysiloxane, poly(dimethyl siloxane), poly(alkyl siloxane), poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), chains of ethylene glycol phenyl ether acrylate) (PEGPEA) or ethoxylated trimethyl propyl triacrylate (ETPTA), poly(phosphate), poly(phosphonate), poly(phosphinate), poly(phosphine), poly(phosphine oxide), poly(phosphonic acid), poly(phosphorous acid), poly(phosphite), poly(phosphoric acid), poly(phosphazene), a chemical derivative thereof, a copolymer thereof, a sulfonated derivative thereof, or a combination thereof, wherein said ion-conducting polymer and the conjugate polymer form a polymer blend, a copolymer, a crosslinked network of chains, a semi-interpenetrating network, or a simultaneous interpenetrating network.

In some preferred embodiments, the polymer electrolyte shell further comprises a lithium salt (e.g., 0.1%-60% by weight of a lithium salt dispersed in the polymer electrolyte). The lithium salt is preferably selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4, or a combination thereof.

In some embodiments, the rechargeable lithium cell has the following features:
1) the hybrid solid electrolyte particulates comprise a 1^{st} conductive polymer electrolyte encapsulating inorganic solid electrolyte particles;
2) the anode comprises multiple anode particulates comprising anode active material particles encapsulated by a 2^{nd} polymer electrolyte polymer (preferably a 2^{nd} conductive polymer electrolyte), wherein the 1^{st} conductive polymer electrolyte and the 2^{nd} solid electrolyte polymer are identical or different in chemical composition or structure; and
3) the hybrid solid electrolyte particulates and the anode particulates, along with an optional conductive additive, are compacted or consolidated to form the anode, wherein the 1st conductive polymer electrolyte and the 2^{nd} solid electrolyte polymer form a contiguous pathway for lithium ion transport and electron transport.

The present disclosure also provides an anode that has the above defined features.

In some embodiments, the rechargeable lithium cell has the following features:
1) the hybrid solid electrolyte particulates comprise a 1^{st} conductive polymer electrolyte encapsulating inorganic solid electrolyte particles;
2) the cathode comprises multiple cathode particulates each comprising cathode active material particles encapsulated by a 2^{nd} solid electrolyte polymer (preferably a conductive polymer) or a carbon layer (carbon, graphene, and/or graphite), wherein the 1st conductive polymer electrolyte and the 2^{nd} solid electrolyte polymer are identical or different in chemical composition or structure; and
3) the hybrid solid electrolyte particulates and the cathode particulates, along with an optional conductive additive, are compacted or consolidated to form the cathode, wherein the 1^{st} conductive polymer electrolyte and the 2^{nd} solid electrolyte polymer (or the carbon layer), in combination, form a contiguous pathway for lithium ion transport and electron transport.

The present disclosure also provides a cathode that has the above defined features.

The processes that can be used to produce the hybrid solid electrolyte particulates are briefly described now, but will be further discussed later. For instance, for those conducting polymers that are soluble in a liquid solvent (e.g., linear-chain or branched polymers), one can begin by dissolving a polymer (optionally but preferably, along with a desired amount of a lithium salt) to form a polymer/solvent liquid solution. A desired amount of fine particles (e.g., 5 nm to 10 μm in diameter) of an inorganic solid electrolyte (ISE) are then dispersed into the liquid solution to form a slurry. The slurry may then be formed into hybrid particulates (conducting polymer electrolyte-encapsulated ISE secondary particles) using any known particle-forming procedure combined with solvent removal (e.g., spray-drying).

In some other examples, the polymer electrolyte as the encapsulating shell in the hybrid solid electrolyte particulate comprises a conducting polymer that is a polymerization or crosslinking product of a reactive additive comprising (i) a monomer or oligomer that is polymerizable and/or cross-linkable, (ii) an initiator and/or curing agent, and (iii) a lithium salt (optional but desirable), wherein the monomer/oligomer (or un-cured polymer) occupies from 1% to 99% by weight based on the total weight of the reactive additive.

In these examples, a desired amount of fine particles of an inorganic solid electrolyte may be dispersed in the reactive additive to form a reactive slurry. The slurry may then be formed into secondary particles having ISE particles being embraced with a thin layer of reactive additive. This is followed by polymerization and/or crosslinking to form the hybrid solid electrolyte particulates, wherein each particulate comprises one or more than one primary particles of an ISE being encapsulated by a substantially solid polymer electrolyte. Preferably, at least 30% by weight of the monomer/oligomer is eventually polymerized/crosslinked; more preferably >50%, further preferably >70%, and most preferably >99% is polymerized/crosslinked.

In certain embodiments, the polymerizable/cross-linkable monomer/oligomer is chemically bonded to the chains selected from the group consisting of vinylene carbonate, ethylene carbonate, fluoroethylene carbonate, ethylene glycol phenyl ether acrylate) (PEGPEA), ethoxylated trimethyl propyl triacrylate (ETPTA), tetrahydrofuran (THF), vinyl sulfite, vinyl ethylene sulfite, vinyl ethylene carbonate, 1,3-propyl sultone, 1,3,5-trioxane (TXE), 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones (including alkyl siloxanes, etc.), sulfides, dinitriles, acrylonitrile (AN), sulfates, siloxanes, silanes, N-methylacetamide, acrylates, ethylene glycols, phosphates, phosphonates, phosphinates, phosphines, phosphine oxides, phosphonic acids, phosphorous acid, phosphites, phosphoric acids, phosphazene compounds, derivatives thereof, and combinations thereof. Such chemical bonding may be in the form of copolymerization, grafting, cross-linking, etc.

It is uniquely advantageous to be able to fully polymerize/crosslink the monomer/oligomer once the liquid electrolyte (having a lithium salt dissolved in the monomer/oligomer liquid or a crosslinked polymer in a solution) is used to form a shell that embraces and encapsulating single or multiple inorganic solid electrolyte (ISE) particles. The hybrid solid electrolyte particulates (secondary particles) can then be utilized in the anode and/or the cathode. For instance, multiple hybrid solid electrolyte particulates may be mixed with a desired amount of an anode active material (e.g., graphite, Si, SiO particles) to form an anode (negative electrode) using a conventional electrode fabrication procedure (e.g., slurry coating process). Similarly, multiple hybrid solid electrolyte particulates may also be mixed with a desired amount of a cathode active material (e.g., lithium iron phosphate and lithium metal oxide particles) to form a cathode (positive electrode) using a conventional electrode fabrication procedure (e.g., slurry coating process). This strategy enables us to achieve several desirable attributes of the resultant hybrid electrolyte, electrodes, and cell:
1) no liquid electrolyte leakage issue in a battery cell;
2) adequate amount of lithium salt dispersed in the conducting polymer electrolyte shell to impart a good lithium-ion conductivity to the polymer shell (conjugate polymer itself is electron-conducting);
3) good lithium-ion conductivity and electron conductivity of the all-solid hybrid electrolyte particulates (reduced need to have a conductive additive in the anode or cathode);
4) eliminated flammability of the battery cell;
5) good mixing of the electrolyte particles with the anode or cathode active material particles, enabling significantly reduced interfacial impedance and improved utilization of the active material (hence, higher energy density);
6) the polymer deformability or flexibility of the encapsulating shell facilitates good contact between the hybrid electrolyte particulates and anode or cathode active material particles during battery charging or discharging; and
7) processing ease, including compatibility with current lithium-ion battery production processes and equipment.
   These features provide significant utility value since most of the organic solvents commonly used in the lithium battery are known to be volatile and flammable, posing a fire and explosion danger. Further, current solid-state electrolytes are not compatible with existing lithium-ion battery manufacturing equipment and processes.

In certain preferred embodiments, the polymer electrolyte shell further comprises a flame retardant selected from an organic phosphorus compound, an inorganic phosphorus compound, a halogenated derivative thereof, or a combination thereof. The organic phosphorus compound or the inorganic phosphorus compound preferably is selected from the group consisting of phosphates, phosphonates, phosphonic acids, phosphorous acids, phosphites, phosphoric acids, phosphinates, phosphines, phosphine oxides, phosphazene compounds, derivatives thereof, and combinations thereof. These compounds may be polymerized to become part of the encapsulating shell.

Preferably, the lithium salt occupies 0.1%-50% by weight and the crosslinking agent and/or initiator occupies 0.1-50% by weight of the reactive additive.

The conducting polymer electrolyte shell may be in a form of a mixture, copolymer, semi-interpenetrating network, or simultaneous interpenetrating network with a second polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene (PVDF-HFP), cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof. This second polymer may be pre-mixed into the polymerizable monomer/oligomer. Alternatively, this second polymer may be dissolved in the liquid solvent where appropriate to form a solution prior to being combined with the ISE particles.

The present disclosure also provides a rechargeable lithium cell that comprises an anode, a cathode, and a separator disposed between the anode and the cathode. Preferably, the anode and/or the cathode comprises the presently disclosed hybrid solid electrolyte particulates.

The present disclosure further provides a rechargeable lithium battery, including a lithium metal secondary cell, a lithium-ion cell, a lithium-sulfur cell, a lithium-ion sulfur cell, a lithium-selenium cell, or a lithium-air cell. This battery features a non-flammable, safe, and high-performing electrolyte as herein disclosed.

The hybrid solid electrolyte particulates may be mixed with an electrode active material (e.g., cathode active material particles, such as NCM, NCA and lithium iron phosphate) and a conducting additive (e.g., carbon black, carbon nanotubes, expanded graphite flakes, or graphene sheets) in a liquid medium to form a slurry or paste. The slurry or paste is then made (e.g., using casting or coating) into a desired electrode shape (e.g., cathode electrode), possibly supported on a surface of a current collector (e.g., an Al foil as a cathode current collector). An anode of a lithium-ion cell may be made in a similar manner using an anode active material (e.g., particles of graphite, Si, SiO, etc.). The anode electrode, a cathode electrode, and a separator are then combined to form a battery cell. The separator is preferably made from a composite comprising particles of an ISE dispersed in an ion-conducting polymer that is not electron-conducting.

Still another preferred embodiment of the present disclosure is a rechargeable lithium-sulfur cell or lithium-ion sulfur cell containing a sulfur cathode having sulfur or lithium polysulfide as a cathode active material.

For a lithium metal cell (where lithium metal is the primary active anode material), the anode current collector may comprise a foil, perforated sheet, or foam of a metal having two primary surfaces wherein at least one primary surface is coated with or protected by a layer of lithiophilic metal (a metal capable of forming a metal-Li solid solution or is wettable by lithium ions), a layer of graphene material, or both. The metal foil, perforated sheet, or foam is preferably selected from Cu, Ni, stainless steel, Al, graphene-coated metal, graphite-coated metal, carbon-coated metal, or a combination thereof. The lithiophilic metal is preferably selected from Au, Ag, Mg, Zn, Ti, K, Al, Fe, Mn, Co, Ni, Sn, V, Cr, an alloy thereof, or a combination thereof.

For a lithium ion battery featuring the presently disclosed electrolyte, there is no particular restriction on the selection of an anode active material. The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

In some embodiments, the anode active material contains a prelithiated Si, prelithiated Ge, prelithiated Sn, prelithiated SnOₓ, prelithiated SiOₓ, prelithiated iron oxide, prelithiated V₂O₅, prelithiated V₃O₈, prelithiated Co₃O₄, prelithiated Ni₃O₄, or a combination thereof, wherein x=1 to 2.

The rechargeable lithium cell may further comprise a cathode current collector selected from aluminum foil, carbon- or graphene-coated aluminum foil, stainless steel foil or web, carbon- or graphene-coated steel foil or web, carbon or graphite paper, carbon or graphite fiber fabric, flexible graphite foil, graphene paper or film, or a combination thereof. A web means a screen-like structure or a metal foam, preferably having interconnected pores or through-thickness apertures.

The present disclosure also provides a powder product comprising multiple hybrid solid electrolyte particulates as defined above. Each hybrid solid electrolyte particulate comprises one or a plurality of the inorganic solid electrolyte (ISE) particles encapsulated by a conducting polymer. For claim definition purposes, this conducting polymer can refer to a fully polymerized and/or fully crosslinked conducting polymer. This conducting polymer can also refer to a precursor to such a polymer, including, for instance, an oligomer, a growing polymer (not yet fully polymerized), or a crosslinkable polymer (not yet fully crosslinked). Such a live or reactive powder product makes it convenient for a battery cell producer to more readily form and consolidate an anode or a cathode at its own facility according to its own schedule.

Also provided is an anode comprising a mixture of multiple anode active material particles and multiple hybrid solid electrolyte particulates as defined above. In this anode, the multiple hybrid solid electrolyte particulates may each comprise one or a plurality of particles of the inorganic solid electrolyte encapsulated by a 1^{st} conducting polymer electrolyte and wherein the anode comprises multiple anode particulates each comprising one or a plurality of the anode active material particles encapsulated by a 2^{nd} elastic polymer electrolyte, wherein the 1st conducting polymer electrolyte and the 2^{nd} elastic polymer electrolyte may be identical or different in chemical composition or structure.

The disclosure also provides a cathode comprising a mixture of multiple cathode active material particles and multiple hybrid solid electrolyte particulates as defined above. In this cathode, the multiple hybrid solid electrolyte particulates may each comprise one or a plurality of particles of an inorganic solid electrolyte encapsulated by a 1^{st} conducting polymer electrolyte and wherein the cathode comprises multiple cathode particulates each comprising one or a plurality of the cathode active material particles encapsulated by a 2^{nd} polymer electrolyte (or a carbon shell layer), wherein the 1^{st} conducting polymer electrolyte and the 2^{nd} polymer electrolyte are identical or different in chemical composition or structure.

The present disclosure also provides a process for producing a plurality of the hybrid solid electrolyte particulates as discussed or defined above, the process comprising: (A) dispersing a plurality of primary particles of an inorganic solid electrolyte, having a diameter or thickness from 1 nm to 20 μm, in a reactive liquid mixture of (i) a monomer, oligomer, or cross-linkable polymer (as a precursor to the conducting polymer electrolyte) and (ii) an initiator and/or a cross-linking agent to form a reactive slurry; (B) forming the reactive slurry into micro-droplets; and (C) polymerizing and/or curing the monomer, the oligomer or the cross-linkable polymer in the micro-droplets to form the hybrid solid electrolyte particulates.

The monomer, oligomer, or polymer may be dissolved in an organic solvent elected from tetrahydrofuran, dimethyl sulfoxide, γ-butyrolactone, dimethylacetamide, dimethylformamide, dimethyl sulfite, methyl acetate, methyl formate, nitromethane, propylene carbonate chloro-pentafluoro benzene, methyl tetrahydrofuran, thiophene, dimethyl carbonate, pyridine, sulfolane, or a mixture thereof.

There is no particular restriction on the micro-droplet forming procedure. Preferably, step (B) of forming micro-droplets comprises a procedure selected from pan-coating, air-suspension coating, centrifugal extrusion, vibration-nozzle encapsulation, spray-drying, kneadering, casting and drying, coacervation-phase separation, interfacial polycondensation or interfacial cross-linking, in-situ polymerization, matrix polymerization, extrusion and palletization, or a combination thereof. The micro-droplets contain water or a liquid solvent and the process further comprises a step of removing the water or solvent.

The process may further comprise a step of combining the hybrid solid electrolyte particulates, particles of an anode active material, and a conductive additive into an anode electrode; or a step of combining the hybrid solid electrolyte particulates, particles of a cathode active material, and a conductive additive into a cathode electrode.

The disclosure also provides a process for producing a plurality of the hybrid solid electrolyte particulates as defined earlier, the process comprising: (a) dispersing a plurality of primary particles of an inorganic solid electrolyte, having a diameter or thickness from 1 nm to 20 μm, in a liquid solution, comprising a conducting polymer dissolved in a liquid solvent, to form a slurry; (b) forming the slurry into micro-droplets; and (c) removing the liquid solvent in the micro-droplets to form the hybrid solid electrolyte particulates. The micro-droplet forming procedure may be selected from pan-coating, air-suspension coating, centrifugal extrusion, vibration-nozzle encapsulation, spray-drying, extrusion and palletization, kneadering, or a combination thereof.

The liquid solvent may be elected from tetrahydrofuran, dimethyl sulfoxide, γ-butyrolactone dimethylacetamide, dimethylformamide, dimethyl sulfite, methyl acetate, methyl formate, nitromethane, propylene carbonate, chloro-pentafluoro benzene, methyl tetrahydrofuran thiophene dimethyl carbonate, pyridine, sulfolane, or a mixture thereof.

Regardless how the hybrid solid electrolyte particulate are made, the process may further comprise a step of combining and consolidating (i) the hybrid solid electrolyte particulates having a 1^{st} solid electrolyte polymer encapsulating inorganic solid electrolyte particles and (ii) anode or cathode active material particles encapsulated by a 2^{nd} solid electrolyte polymer, along with an optional conductive additive, to form an anode or cathode electrode, wherein the 1^{st} solid electrolyte polymer and the 2^{nd} solid electrolyte polymer are identical or different in chemical composition or structure.

These and other advantages and features of the present invention will become more transparent with the description of the following best mode practice and illustrative examples.

### BRIEF DESCRIPTION OF THE DRAWINGS

FIG. 1(A) Schematic of hybrid solid electrolyte particulates according to certain embodiments of the present disclosure;

FIG. 1(B) A process flow chart to illustrate a process for producing a plurality of hybrid solid electrolyte particulates according to some embodiments of the present disclosure;

FIG. 1(C) Another process flow chart to illustrate a process for producing a plurality of hybrid solid electrolyte particulates according to some embodiments of the present disclosure.

FIG. 1(D) A chart to illustrate a process for producing an electrode (anode or cathode) by mixing and consolidating a plurality of hybrid solid electrolyte particulates (containing a 1^{st} conducting solid polymer electrolyte encapsulating ISE particles) and a plurality of particulates each comprising one or more than one active material particles encapsulated by a 2^{nd} solid electrolyte polymer (or a carbon shell layer), according to some embodiments of the present disclosure.

FIG. 2(A) Structure of an anode-less lithium metal cell (as manufactured or in a discharged state) according to some embodiments of the present disclosure;

FIG. 2(B) Structure of an anode-less lithium metal cell (in a charged state) according to some embodiments of the present disclosure.

### DETAILED DESCRIPTION

The present disclosure provides hybrid solid electrolyte particulates for use as a solid electrolyte for a safe and high-performing lithium battery, which can be any of various types of lithium-ion cells or lithium metal cells. A high degree of safety is imparted to this battery by a novel and unique electrolyte that is highly flame-resistant and would not initiate a fire or sustain a fire and, hence, would not pose explosion danger. This disclosure has solved the very most critical issue that has plagued the lithium-metal and lithium-ion industries for more than two decades.

As indicated earlier in the Background section, a strong need exists for a safe, non-flammable, yet process-friendly solid-state electrolyte system for a rechargeable lithium cell that is compatible with existing battery production facilities. It is well-known in the art that the conventional solid-state electrolyte batteries typically cannot be produced using existing lithium-ion battery production equipment or processes.

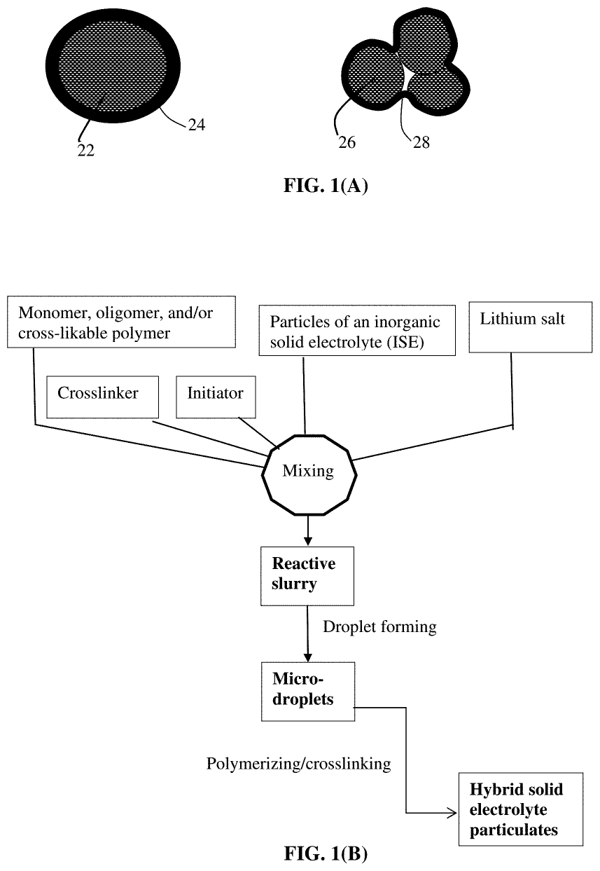

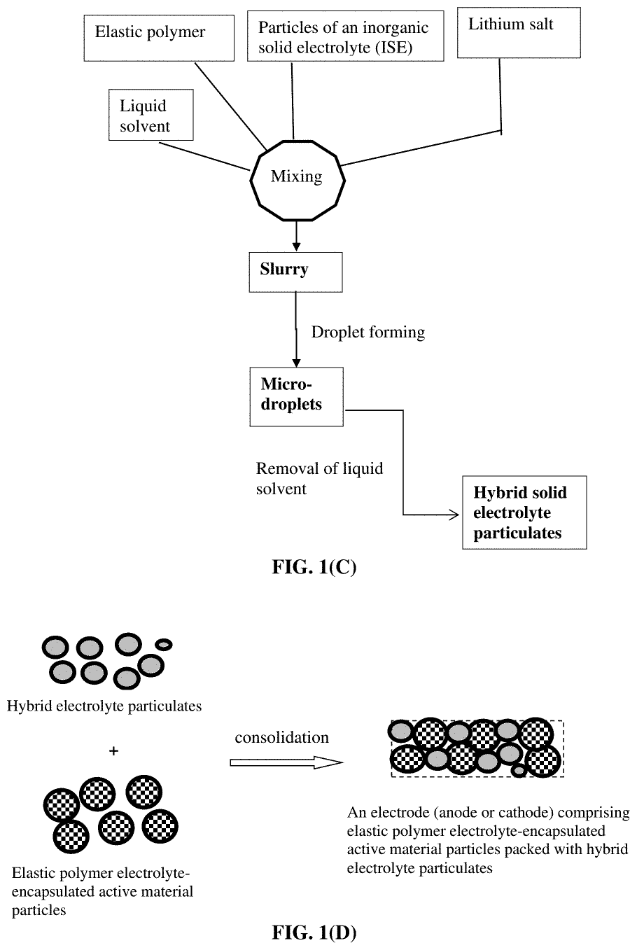

As illustrated in FIG. 1(A), the disclosed hybrid solid electrolyte particulate comprises one particle (e.g., 22) or a plurality of particles (e.g., 26) of an inorganic solid electrolyte (ISE) encapsulated by a shell of a conducting polymer electrolyte (e.g., 24, 28). This particulate or secondary particle has three main features: (i) the hybrid solid electrolyte particulate has a lithium-ion conductivity from 10⁻⁶ S/cm to 5×10⁻² S/cm and both the inorganic solid electrolyte and the polymer electrolyte individually have a lithium-ion conductivity no less than 10⁻⁶ S/cm; (ii) the conducting polymer electrolyte has an electron conductivity no less than 10⁻⁶ S/cm; and (iii) the polymer electrolyte-to inorganic solid electrolyte ratio is from 1/100 to 100/1 or the polymer electrolyte shell has a thickness from 1 nm to 10 μm. The encapsulating polymer shell preferably has a thickness from 2 nm to 2 μm, more preferably less than 1 μm, and most preferably less than 500 nm. In certain embodiments, the inorganic solid electrolyte material particles are preferably from 5 nm to 20 μm in diameter, more preferably from 20 nm to 10 μm, and most preferably smaller than 5 μm).

Preferably, the hybrid electrolyte particle has a lithium-ion conductivity from 10⁻⁵ S/cm to 5×10⁻² S/cm. Preferably, the elastic polymer electrolyte alone (without the ISE) has a lithium-ion conductivity from 10⁻⁸ S/cm to 5×10⁻² S/cm, more typically from 10⁻⁶ S/cm to 10⁻² S/cm, more preferably greater than 10⁻⁵ S/cm, further more preferably greater than 10⁻⁴ S/cm, and most preferably greater than 10⁻³ S/cm.

Also provided is a lithium-ion or lithium metal cell containing multiple hybrid solid electrolyte particulates in the anode and/or the cathode. The disclosure further provides an anode or a cathode that comprises the presently disclosed multiple hybrid solid electrolyte particulates or an electrolyte derived from the presently disclosed multiple hybrid solid electrolyte particulates.

In certain embodiments, the conducting polymer electrolyte comprises a linear, branched, or network of crosslinked chains comprising chains of a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly [(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof. In some preferred embodiments, the conducting polymer comprises a network of crosslinked chains comprising polyaniline, polypyrrole, or polythiophene chains.

The conducting polymer may preferably comprise a network of crosslinked chains comprising chains of a conjugate polymer and chains selected from polyethylene oxide, polypropylene oxide, pentaerythritol tetra-acrylate, poly(ethylene glycol) diacrylate, poly(ethylene glycol) methyl ether acrylate, poly(ethylene glycol phenyl ether acrylate) (PEGPEA), ethoxylated trimethyl propyl tri-acrylate (ETPTA), or a combination thereof. These polymer chains, when combined with a conjugate polymer, provide a network polymer that is both ion-conducting and electron-conducting.

The conducting polymer electrolyte may further comprise a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, poly(alkylsiloxane), poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyacrylamide, a polyionic liquid, polymerized 1,3-dioxolane, polyepoxide ether, polysiloxane, poly(dimethyl siloxane), poly(alkyl siloxane), poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), chains of ethylene glycol phenyl ether acrylate) (PEGPEA) or ethoxylated trimethyl propyl triacrylate (ETPTA), poly(phosphate), poly(phosphonate), poly(phosphinate), poly(phosphine), poly(phosphine oxide), poly(phosphonic acid), poly(phosphorous acid), poly(phosphite), poly(phosphoric acid), poly(phosphazene), a chemical derivative thereof, a copolymer thereof, a sulfonated derivative thereof, or a combination thereof, wherein said ion-conducting polymer and the conjugate polymer form a polymer blend, a copolymer, a crosslinked network of chains, a semi-interpenetrating network, or a simultaneous interpenetrating network.

In some embodiments, the conducting polymer shell comprises a lithium ion-conducting additive dispersed therein, wherein the lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4. In some embodiments, the lithium ion-conducting additive contains a lithium salt selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

The inorganic solid electrolyte material may be selected from an oxide type, sulfide type (including, but not limited to, the thio-LISICON type, glass-type, glass ceramic-type, and argyrodite-type sulfide electrolyte), hydride type, halide type, borate type, phosphate type, lithium phosphorus oxynitride (LiPON), garnet-type, lithium superionic conductor (LISICON) type, sodium superionic conductor (NASICON) type, or a combination thereof.

The inorganic solid electrolyte particles that can be incorporated into the hybrid electrolyte include, but are not limited to, oxide-type, such as perovskite-type, garnet-type, NASICON-type, and sulfide-type materials. A representative perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in a polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid-state electrolyte for the lithium-ion battery. The ionic conductivity of LiZr₂(PO₄)₃ is very low, but can be improved by the substitution of Hf or Sn. This can be further enhanced with substitution to form Li₁₊ₓMₓTi₂₋ₓ(PO₄)₃ (M=Al, Cr, Ga, Fe, Sc, In, Lu, Y or La). Al substitution has been demonstrated to be the most effective solid-state electrolyte. The Li₁₊ₓAlₓGe₂₋ₓ(PO₄)₃ system is also an effective solid state due to its relatively wide electrochemical stability window. NASICON-type ma s are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂ (M=W or Te), a broad series of garnet-type materials may be used as an additive, including Li₅La₃M₂O₁₂ (M=Nb or Ta), Li₆ALa₂M₂O₁₂ (A=Ca, Sr or Ba; M=Nb or Ta), Li_{5.5}La₃M_{1.75}B_{0.25}O₁₂ (M=Nb or Ta; B=In or Zr) and the cubic systems Li₇La₃Zr₂O₁₂ and Li_{7.06}M₃Y_{0.06}Zr_{1.94}O₁₂ (M=La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include the Li₂S—SiS₂ system. The conductivity in this type of material is 6.9×10⁻⁴ S/cm, which was achieved by doping the Li₂S—SiS₂ system with Li₃PO₄. Other sulfide-type solid-state electrolytes can reach a good lithium-ion conductivity close to 10⁻² S/cm. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer as herein disclosed.

These inorganic solid electrolyte (ISE) particles encapsulated by an elastic electrolyte polymer shell can help enhance the lithium ion conductivity of certain polymers that have a lower ion conductivity than the encapsulated SEI. Preferably and typically, the conducting polymer electrolyte has a lithium ion conductivity no less than 10⁻⁵ S/cm, more desirably no less than 10⁻⁴ S/cm, further preferably no less than 10⁻³ S/cm, and most preferably no less than 10⁻² S/cm.

It should be noted that certain inorganic solid electrolytes (e.g., sulfide type ISE) can have a higher lithium-ion conductivity as compared to certain selected polymers. However, sulfide type ISEs are air-sensitive and air-sensitive and, hence, cannot be combined with an anode active material (e.g., graphite or Si) to form an anode using water as a liquid medium in a commonly used slurry coating process. Furthermore, sulfide-type ISEs have a very narrow electrochemical stability window (e.g., from 1.8-2.5 V relative to Li/Li⁺), making them unsuitable for use in the anode, where lithium ion intercalation occurs at approximately 0.23 V for graphite and 0.5 V for Si (significantly lower than 1.8 V). They are also unsuitable for the cathode since the cathode active material typically operates at 3.2-4.4 V for lithium iron phosphate and all lithium transition metal oxides. We have solved this problem by encapsulating the ISE particles with a polymer electrolyte that typically has a significantly wider electrochemical stability window (e.g., can be from 0 to 4.5 V relative to Li/Li⁺). The polymer protection also enables the ISEs processible using the current lithium-ion cell production processes.

The intended conducting polymer typically is initially in a monomer, oligomer, partially polymerized, or partially crosslinked state (herein referred to as the conducting polymer precursor) having a lithium salt dissolved therein. The precursor is then combined with ISE particles to form micro-droplets that are composed of ISE particles encapsulated by the polymer precursor. This is followed by further or fully polymerizing or crosslinking the precursor to form a shell that embraces and encapsulates single or multiple inorganic solid electrolyte (ISE) particles.

The hybrid solid electrolyte particulates (secondary particles) can then be utilized in the anode and/or the cathode of a lithium battery cell. Multiple hybrid solid electrolyte particulates may also be mixed with a desired amount of an anode active material (e.g., graphite, Si, SiO particles, etc.) to form an anode (negative electrode) using a conventional electrode fabrication procedure (e.g., slurry coating process). Similarly, multiple hybrid solid electrolyte particulates may also be mixed with a desired amount of a cathode active material (e.g., lithium iron phosphate and lithium metal oxide particles) to form a cathode (positive electrode) using a conventional electrode fabrication procedure (e.g., slurry coating process). This strategy enables us to achieve several desirable attributes of the resultant hybrid electrolyte, electrodes, and cell, as discussed in the Summary section.

The conducting polymer shell in the hybrid solid electrolyte particulates facilitate the formation of a contiguous network of lithium ion-conducting pathways if these particulates are mixed and compacted together with particulates of anode or cathode active material particles encapsulated by a shell of ion- and electron-conducting polymer or carbon (e.g., amorphous carbon, CVD carbon, polymeric carbon, graphene, and/or graphite).

The cathode may contain a cathode active material (along with an optional conductive additive and an optional resin binder) and an optional cathode current collector (such as Al foil) supporting the cathode active material. The anode may have an anode current collector, with or without an anode active material in the beginning when the cell is made. It may be noted that if no conventional anode active material, such as graphite, Si, SiO, Sn, and conversion-type anode materials, and no lithium metal is present in the cell when the cell is made and before the cell begins to charge and discharge, the battery cell is commonly referred to as an “anode-less” lithium cell.

In certain embodiments, the encapsulating shell of conducting polymer may comprise a flame-resisting or flame-retardant ingredient selected from an organic phosphorus compound, an inorganic phosphorus compound, a halogenated derivative thereof, a polymerized version thereof, or a combination thereof. The organic phosphorus compound or the inorganic phosphorus compound preferably is selected from the group consisting of phosphates, phosphonates, phosphonic acids, phosphorous acids, phosphites, phosphoric acids, phosphinates, phosphine oxides, phosphazene compounds, derivatives thereof, and combinations thereof.

The ion-conducting polymer (e.g., conjugate polymer) in the encapsulating shell may be in a form of a polymer blend, copolymer, semi-interpenetrating network, or simultaneous interpenetrating network with an ion-conducting polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

The inorganic solid electrolyte particles encapsulated by an electrolyte polymer can help enhance the lithium-ion conductivity of the resulting hybrid solid electrolyte particulates if the encapsulating polymer has an intrinsically low ion conductivity. Preferably and typically, the polymer has a lithium-ion conductivity no less than 10⁻⁵ S/cm, more preferably no less than 10⁻⁴ S/cm, and further preferably no less than 10⁻³ S/cm.

The disclosed lithium battery can be a lithium-ion battery or a lithium metal battery, the latter having lithium metal as the primary anode active material. The lithium metal battery can have lithium metal implemented at the anode when the cell is made. Alternatively, the lithium may be stored in the cathode active material and the anode side is lithium metal-free initially. This is called an anode-less lithium metal battery.

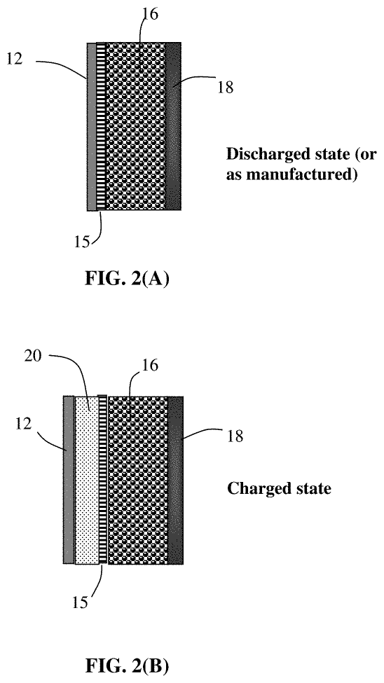

As illustrated in FIG. 2(A), the anode-less lithium cell is in an as-manufactured or fully discharged state according to certain embodiments of the present disclosure. The cell comprises an anode current collector 12 (e.g., Cu foil), a separator, a cathode layer 16 comprising a cathode active material, an optional conductive additive (not shown), an optional resin binder (not shown), and a plurality of the presently disclosed hybrid solid electrolyte particulates (dispersed in the entire cathode layer and in contact with the cathode active material), and a cathode current collector 18 that supports the cathode layer 16. There is no lithium metal in the anode side when the cell is manufactured. The separator can be a polymeric membrane, solid-state electrolyte, or preferably a separator made from consolidation of multiple hybrid solid electrolyte particulates herein provided.

In a charged state, as illustrated in FIG. 2(B), the cell comprises an anode current collector 12, lithium metal 20 plated on a surface (or two surfaces) of the anode current collector 12 (e.g., Cu foil), a separator 15, a cathode layer 16, and a cathode current collector 18 supporting the cathode layer. The lithium metal comes from the cathode active material (e.g., LiCoO₂ and LiMn₂O₄) that contains Li element when the cathode is made. During a charging step, lithium ions are released from the cathode active material and move to the anode side to deposit onto a surface or both surfaces of an anode current collector.

One unique feature of the presently disclosed anode-less lithium cell is the notion that there is substantially no anode active material and no lithium metal is present when the battery cell is made. The commonly used anode active material, such as an intercalation type anode material (e.g., graphite, carbon particles, Si, SiO, Sn, SnO₂, Ge, etc.), P, or any conversion-type anode material, is not included in the cell. The anode only contains a current collector or a protected current collector. No lithium metal (e.g., Li particle, surface-stabilized Li particle, Li foil, Li chip, etc.) is present in the anode when the cell is made; lithium is basically stored in the cathode (e.g., Li element in LiCoO₂, LiMn₂O₄, lithium iron phosphate, lithium polysulfides, lithium polyselenides, etc.). During the first charge procedure after the cell is sealed in a housing (e.g., a stainless steel hollow cylinder or an Al/plastic laminated envelop), lithium ions are released from these Li-containing compounds (cathode active materials) in the cathode, travel through the electrolyte/separator into the anode side, and get deposited on the surfaces of an anode current collector. During a subsequent discharge procedure, lithium ions leave these surfaces and travel back to the cathode, intercalating or inserting into the cathode active material.

Such an anode-less cell is much simpler and more cost-effective to produce since there is no need to have a layer of anode active material (e.g., graphite particles, along with a conductive additive and a binder) pre-coated on the Cu foil surfaces via the conventional slurry coating and drying procedures. The anode materials and anode active layer manufacturing costs can be saved. Furthermore, since there is no anode active material layer (otherwise typically 40-200 μm thick), the weight and volume of the cell can be significantly reduced, thereby increasing the gravimetric and volumetric energy density of the cell.

Another important advantage of the anode-less cell is the notion that there is no lithium metal in the anode when a lithium metal cell is made. Lithium metal (e.g., Li metal foil and particles) is highly sensitive to air moisture and oxygen and notoriously known for its difficulty and danger to handle during manufacturing of a Li metal cell. The manufacturing facilities should be equipped with special class of dry rooms, which are expensive and significantly increase the battery cell costs.

The anode current collector may be selected from a foil, perforated sheet, or foam of Cu, Ni, stainless steel, Al, graphene, graphite, graphene-coated metal, graphite-coated metal, carbon-coated metal, or a combination thereof. Preferably, the current collector is a Cu foil, Ni foil, stainless steel foil, graphene-coated Al foil, graphite-coated Al foil, or carbon-coated Al foil.

The anode current collector typically has two primary surfaces. Preferably, one or both of these primary surfaces is deposited with multiple particles or coating of a lithium-attracting metal (lithiophilic metal), wherein the lithium-attracting metal, preferably having a diameter or thickness from 1 nm to 10 μm, is selected from Au, Ag, Mg, Zn, Ti, K, Al, Fe, Mn, Co, Ni, Sn, V, Cr, an alloy thereof, or a combination thereof. This deposited metal layer may be further deposited with a layer of graphene that covers and protects the multiple particles or coating of the lithiophilic metal.

The graphene layer may comprise graphene sheets selected from single-layer or few-layer graphene, wherein the few-layer graphene sheets are commonly defined to have 2-10 layers of stacked graphene planes having an inter-plane spacing d₀₀₂ from 0.3354 nm to 0.6 nm as measured by X-ray diffraction. The single-layer or few-layer graphene sheets may contain a pristine graphene material having essentially zero % of non-carbon elements, or a non-pristine graphene material having 0.001% to 45% by weight of non-carbon elements. The non-pristine graphene may be selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

The graphene layer may comprise graphene balls and/or graphene foam. Preferably, the graphene layer has a thickness from 1 nm to 50 μm and/or has a specific surface area from 5 to 1000 m²/g (more preferably from 10 to 500 m²/g).

For a lithium-ion battery featuring the presently disclosed electrolyte, there is no particular restriction on the selection of an anode active material. The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

In addition to the non-flammability and high lithium ion transference numbers, there are several additional benefits associated with using the presently disclosed solid-state electrolytes. As one example, these electrolytes can significantly enhance cycling and safety performance of rechargeable lithium batteries through effective suppression of lithium dendrite growth. Due to a good contact between the electrolyte and an electrode, the interfacial impedance can be significantly reduced.

As another benefit example, this electrolyte is capable of inhibiting lithium polysulfide dissolution at the cathode and migration to the anode of a Li—S cell, thus overcoming the polysulfide shuttle phenomenon and allowing the cell capacity not to decay significantly with time. Consequently, a coulombic efficiency nearing 100% along with long cycle life can be achieved.

There is also no restriction on the type of the cathode materials that can be used in practicing the present disclosure. For Li—S cells, the cathode active material may contain lithium polysulfide or sulfur. If the cathode active material includes lithium-containing species (e.g., lithium polysulfide) when the cell is made, there is no need to have a lithium metal pre-implemented in the anode.

There are no particular restrictions on the types of cathode active materials that can be used in the presently disclosed lithium battery, which can be a primary battery or a secondary battery. The rechargeable lithium metal or lithium-ion cell may preferably contain a cathode active material selected from, as examples, a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

In a rechargeable lithium cell, the cathode active material may be selected from a metal oxide, a metal oxide-free inorganic material, an organic material, a polymeric material, sulfur, lithium polysulfide, selenium, or a combination thereof. The metal oxide-free inorganic material may be selected from a transition metal fluoride, a transition metal chloride, a transition metal dichalcogenide, a transition metal trichalcogenide, or a combination thereof. In a particularly useful embodiment, the cathode active material is selected from FeF₃, FeCl₃, CuCl₂, TiS₂, TaS₂, MoS₂, NbSe₃, MnO₂, CoO₂, an iron oxide, a vanadium oxide, or a combination thereof, if the anode contains lithium metal as the anode active material. The vanadium oxide may be preferably selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5. For those cathode active materials containing no Li element therein, there should be a lithium source implemented in the cathode side to begin with. This can be any compound that contains a high lithium content, or a lithium metal alloy, etc.

In a rechargeable lithium cell (e.g., the lithium-ion battery cell), the cathode active material may be selected to contain a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

Particularly desirable cathode active materials comprise lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganese (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

In a preferred lithium metal secondary cell, the cathode active material preferably contains an inorganic material selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof. Again, for those cathode active materials containing no Li element therein, there should be a lithium source implemented in the cathode side to begin with.

In another preferred rechargeable lithium cell (e.g. a lithium metal secondary cell or a lithium-ion cell), the cathode active material contains an organic material or polymeric material selected from Poly(anthraquinonyl sulfide) (PAQS), lithium oxocarbons (including squarate, croconate, and rhodizonate lithium salts), oxacarbon (including quinines, acid anhydride, and nitrocompound), 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material (redox-active structures based on multiple adjacent carbonyl groups (e.g., “C₆O₆”-type structure, oxocarbons), Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)6), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAM), calixquinone, Li₄C₆O₆, Li₂C₆O₆, Li₆C₆O₆, or a combination thereof.

The thioether polymer may be selected from Poly[methanetetryl-tetra(thiomethylene)] (PMTTM), Poly(2,4-dithiopentanylene) (PDTP), or Poly(ethene-1,1,2,2-tetrathiol) (PETT) as a main-chain thioether polymer, in which sulfur atoms link carbon atoms to form a polymeric backbones. The side-chain thioether polymers have polymeric main-chains that include conjugating aromatic moieties, but having thioether side chains as pendants. Among them Poly(2-phenyl-1,3-dithiolane) (PPDT), Poly(1,4-di(1,3-dithiolan-2-yl)benzene) (PDDTB), poly(tetrahydrobenzodithiophene) (PTHBDT), and poly[1,2,4,5-tetrakis(propylthio)benzene] (PTKPTB) have a polyphenylene main chain, linking thiolane on benzene moieties as pendants. Similarly, poly[3,4(ethylenedithio)thiophene] (PEDTT) has polythiophene backbone, linking cyclo-thiolane on the 3,4-position of the thiophene ring.

In yet another preferred rechargeable lithium cell, the cathode active material contains a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof. This class of lithium secondary batteries has a high capacity and high energy density. Again, for those cathode active materials containing no Li element therein, there should be a lithium source implemented in the cathode side to begin with.

The processes that can be used to produce the hybrid solid electrolyte particulates are herein further discussed. For convenience, we will divide the conducting polymers into two types. The first type contains those polymers that have been fully polymerized and not cross-linkable (e.g., linear-chain or branched polymers that can be dissolved in a liquid solvent). The second type contains those materials that remain in the monomer state (e.g., monomer+initiator+optional curing agent), oligomer state (live short chains that are capable of growing and/or cross-linking), or cross-linkable polymer (e.g., having at least 3 functional groups for reacting with other chains or curing agents).

As illustrated in FIG. 1(C), for those first-type polymers that are soluble in a liquid solvent one can begin by dissolving a polymer (optionally but preferably, along with a desired amount of a lithium salt) to form a polymer/solvent liquid solution. A desired amount of fine particles (e.g., 5 nm to 10 μm in diameter) of an inorganic solid electrolyte (ISE) are then dispersed into the liquid solution to form a slurry. The slurry may then be formed into hybrid particulates (polymer electrolyte-encapsulated ISE secondary particles) using any known particle-forming procedure combined with solvent removal (e.g., spray-drying).

The liquid solvent may be preferably elected from tetrahydrofuran, dimethyl sulfoxide, γ-butyrolactone, dimethylacetamide, dimethylformamide; dimethyl sulfite, methyl acetate, methyl formate, nitromethane, propylene carbonate, chloro-pentafluoro benzene, methyl tetrahydrofuran, thiophene, dimethyl carbonate, pyridine, sulfolane, or a mixture thereof.

In some other examples based on the second-type polymers (illustrated in FIG. 1(B)), the polymer electrolyte as the encapsulating shell in the hybrid solid electrolyte particulate comprises a polymer that is a polymerization or crosslinking product of a reactive additive comprising (i) a first liquid solvent that is polymerizable and/or cross-linkable, and/or (ii) an initiator and/or curing agent, and (iii) a lithium salt (optional but desirable), wherein the first liquid solvent occupies from 1% to 99% by weight based on the total weight of the reactive additive.

In these examples, a desired amount of fine particles of an inorganic solid electrolyte may be dispersed in the reactive additive to form a reactive slurry. The slurry may then be formed into secondary particles having ISE particles being embraced with a thin layer of reactive additive. This is followed by polymerization and/or crosslinking to form the hybrid solid electrolyte particulates, wherein each particulate comprises one or more than one primary particles of an ISE being encapsulated by a substantially solid polymer electrolyte. Preferably, at least 30% by weight of the polymerizable precursor is polymerized; more preferably >50%, further preferably >70%, and most preferably >99% is polymerized.

Shown in FIG. 1(D) is a schematic to illustrate a process for producing an electrode (anode or cathode) by mixing and consolidating (i) a plurality of hybrid solid electrolyte particulates each containing a 1^{st} conducting solid polymer electrolyte encapsulating ISE particles; (ii) a plurality of particulates each comprising one or more than one active (anode or cathode) material particles encapsulated by a 2^{nd} solid electrolyte polymer (preferably also conducting); and optionally (iii) conducting additive. The 1^{st} conducting electrolyte polymer may be identical to or different than the 2^{nd} electrolyte polymer. These hybrid solid electrolyte particulates and the active material particulates are preferably packed together in such a manner that the polymers in the shell form a contiguous phase capable of transporting lithium ions and electrons. Further preferably, the 1^{st} and the 2^{nd} electrolyte polymers are fused or consolidated together.

Several micro-encapsulation processes require the polymer to be dissolvable in a solvent or its precursor (e.g., monomer or oligomer) initially contains a liquid state (flowable). Fortunately, all the polymers or their precursors used herein are soluble in some common solvents or the monomer or other polymerizing/curing ingredients are in a liquid state to begin with.

Some conducting polymers are originally in a multi-functional chemical state that can be cured to form a cross-linked polymer. Prior to curing, these polymers or oligomers are soluble in an organic solvent to form a polymer solution. Particles of an anode active material (e.g., SnO₂ nano particles and Si nano-wires) can be dispersed in this polymer solution to form a suspension (dispersion or slurry) of an active material particle-polymer mixture. This suspension can then be subjected to a solvent removal treatment while individual particles remain substantially separated from one another. The polymer precipitates out to deposit on surfaces of these active material particles. This can be accomplished, for instance, via spray drying.

Hybrid solid electrolyte particulates may be produced in a similar manner by replacing those active material particles with particles of an ISE. Encapsulated cathode active materials may also be produced in a similar manner.

There are three broad categories of micro-encapsulation methods that can be implemented to produce electrolyte polymer-embedded or encapsulated anode particles (the micro-droplets): physical methods, physico-chemical methods, and chemical methods. The physical methods include pan-coating, air-suspension coating, centrifugal extrusion, vibration nozzle, and spray-drying methods. The physico-chemical methods include ionotropic gelation and coacervation-phase separation methods. The chemical methods include interfacial polycondensation, interfacial cross-linking, in-situ polymerization, and matrix polymerization. In all of these methods, polymerization and/or crosslinking may be allowed to proceed during and/or after the micro-droplet formation procedure.

Pan-coating method: The pan coating process involves tumbling the primary particles of an inorganic solid electrolyte (ISE) in a pan or a similar device while the matrix material (e.g., monomer/oligomer liquid or uncured polymer/solvent solution; possibly containing a lithium salt dispersed or dissolved therein) is applied slowly until a desired amount of particulates is attained.

Air-suspension coating method: In the air suspension coating process, the solid primary particles of an ISE are dispersed into the supporting air stream in an encapsulating chamber. A controlled stream of a reactive precursor solution (e.g., polymer or its monomer or oligomer dissolved in a solvent; or its monomer or oligomer alone in a liquid state) is concurrently introduced into this chamber, allowing the solution to hit and coat/embed the suspended particles. These suspended particles are encapsulated by or embedded in the reactive precursor (monomer, oligomer, etc. which is polymerized/cured concurrently or subsequently) while the volatile solvent is removed, leaving behind a hybrid particulate. This process may be repeated several times until the required parameters, such as full-encapsulation, are achieved. The air stream which supports the ISE particles also helps to dry them, and the rate of drying is directly proportional to the temperature of the air stream, which can be adjusted for an optimized polymer amount.

In a preferred mode, the ISE particles in the encapsulating zone portion may be subjected to re-circulation for repeated coating. Preferably, the encapsulating chamber is arranged such that the particles pass upwards through the encapsulating zone, then are dispersed into slower moving air and sink back to the base of the encapsulating chamber, enabling repeated passes of the particles through the encapsulating zone until the desired encapsulating polymer or precursor amount is achieved.

Centrifugal extrusion: Primary anode particles may be embedded in a polymer network or precursor material using a rotating extrusion head containing concentric nozzles. In this process, a stream of core fluid (slurry containing anode particles dispersed in a solvent) is surrounded by a sheath of shell solution or melt containing the polymer or precursor. As the device rotates and the stream moves through the air it breaks, due to Rayleigh instability, into droplets of core, each coated with the shell solution. While the droplets are in flight, the molten shell may be hardened or the solvent may be evaporated from the shell solution. If needed, the capsules can be hardened after formation by catching them in a hardening bath. Since the drops are formed by the breakup of a liquid stream, the process is only suitable for liquid or slurry. A high production rate can be achieved. Up to 22.5 kg of microcapsules can be produced per nozzle per hour and extrusion heads containing 16 nozzles are readily available.

Vibrational nozzle encapsulation method: polymer-encapsulation of ISE particles can be conducted using a laminar flow through a nozzle and vibration of the nozzle or the liquid. The vibration has to be done in resonance with the Rayleigh instability, leading to very uniform droplets. The liquid can consist of any liquids with limited viscosities (1-50,000 mPa·s): emulsions, suspensions or slurry containing the ISE active material particles and the polymer or precursor.

Spray-drying: Spray drying may be used to encapsulate ISE particles when the particles are suspended in a melt or polymer/precursor solution to form a suspension. In spray drying, the liquid feed (solution or suspension) is atomized to form droplets which, upon contacts with hot gas, allow solvent to get vaporized and thin shell of a polymer or precursor to fully embrace the particles.

Coacervation-phase separation: This process consists of three steps carried out under continuous agitation:
(a) Formation of three immiscible chemical phases: liquid manufacturing vehicle phase, core material phase and encapsulation material phase. The ISE primary particles are dispersed in a solution of the encapsulating polymer or precursor. The encapsulating material phase, which is an immiscible polymer in liquid state, is formed by (i) changing temperature in polymer solution, (ii) addition of salt, (iii) addition of non-solvent, or (iv) addition of an incompatible polymer in the polymer solution.
(b) Deposition of encapsulation material: ISE particles being dispersed in the encapsulating polymer solution, encapsulating polymer/precursor coated around ISE particles, and deposition of liquid polymer embracing around ISE particles by polymer adsorbed at the interface formed between core material and vehicle phase; and
(c) Hardening of encapsulating shell material: shell material being immiscible in vehicle phase and made rigid via thermal, cross-linking, or dissolution techniques.

Interfacial polycondensation and interfacial cross-linking: Interfacial polycondensation entails introducing the two reactants to meet at the interface where they react with each other. This is based on the concept of the Schotten-Baumann reaction between an acid chloride and a compound containing an active hydrogen atom (such as an amine or alcohol), polyester, polyurea, polyurethane, or urea-urethane condensation. Under proper conditions, thin flexible encapsulating shell (wall) forms rapidly at the interface. A suspension of the ISE particles and a diacid chloride are emulsified in water and an aqueous solution containing an amine and a polyfunctional isocyanate is added. A base may be added to neutralize the acid formed during the reaction. Condensed polymer shells form instantaneously at the interface of the emulsion droplets. Interfacial cross-linking is derived from interfacial polycondensation, wherein cross-linking occurs between growing polymer chains and a multi-functional chemical group to form a polymer shell material.

In-situ polymerization: In some micro-encapsulation processes, the ISE particles are fully embedded in a monomer or oligomer first. Then, direct polymerization of the monomer or oligomer is carried out with the presence of these material particles dispersed therein.

Matrix polymerization: This method involves dispersing and embedding ISE primary particles in a polymeric matrix during formation of the particles. This can be accomplished via spray-drying, in which the particles are formed by evaporation of the solvent from the matrix material. Another possible route is the notion that the solidification of the matrix is caused by a chemical change.

The following examples are presented primarily for the purpose of illustrating the best mode practice of the present invention, not to be construed as limiting the scope of the present invention.

It may be noted that the more desirable and typical lithium ion conductivity of the polymer herein studied is from 10⁻⁶ S/cm to 1×10⁻² S/cm and that of the inorganic solid electrolyte (ISE) is from 10⁻⁶ S/cm to 5×10⁻² S/cm. The ISE-to-polymer electrolyte volume ratio can be from 1/100 to 100/1, but typically from 5/95 to 95/5, more typically from 10/90 to 90/10, further more typically from 20/80 to 80/20, and most typically from 30/70 to 70/30. The goal is to achieve a lithium ion conductivity of the polymer shell in the resulting hybrid electrolyte particulate from 10⁻⁵ S/cm to 5×10⁻² S/cm, preferably greater than 10⁻⁴ S/cm, and more preferably greater than 10⁻³ S/cm. The electron conductivity of the polymer shell in the resulting hybrid electrolyte particulate is preferably from 10⁻⁶ S/cm to 5×10² S/cm, preferably greater than 10⁻² S/cm, and more preferably greater than 1 S/cm.

### Example 1: Preparation of Inorganic Solid Electrolyte (ISE) Powder, Lithium Nitride Phosphate Compound (LIPON)

Particles of Li₃PO₄ (average particle size 4 μm) and urea were prepared as raw materials; 5 g each of Li₃PO₄ and urea was weighed and mixed in a mortar to obtain a raw material composition. Subsequently, the raw material composition was molded into 1 cm×1 cm×10 cm rod with a molding machine, and the obtained rod was put into a glass tube and evacuated. The glass tube was then subjected to heating at 500° C. for 3 hours in a tubular furnace to obtain a lithium nitride phosphate compound (LIPON). The compound was ground in a mortar into a powder form. These ISE particles can be combined with a conducting polymer to form hybrid solid-state electrolyte particulates for use in an anode and/or a cathode.

### Example 2: Preparation of Solid Electrolyte Powder, Lithium Superionic Conductors with the Li₁₀GeP₂S₁₂ (LGPS)-Type Structure

The starting materials, Li₂S and SiO₂ powders, were milled to obtain fine particles using a ball-milling apparatus. These starting materials were then mixed together with P₂S₅ in the appropriate molar ratios in an Ar-filled glove box. The mixture was then placed in a stainless steel pot, and milled for 90 min using a high-intensity ball mill. The specimens were then pressed into pellets, placed into a graphite crucible, and then sealed at 10 Pa in a carbon-coated quartz tube. After being heated at a reaction temperature of 1,000° C. for 5 h, the tube was quenched into ice water. The resulting inorganic solid electrolyte material was then subjected to grinding in a mortar to form a powder sample to be later added as inorganic solid electrolyte particles encapsulated by an intended conducting polymer electrolyte shell.

### Example 3: Preparation of Garnet-Type Inorganic Solid Electrolyte Powder

The synthesis of the c-Li_{6.25}Al_{0.25}La₃Zr₂O₁₂ was based on a modified sol-gel synthesis-combustion method, resulting in sub-micron-sized particles after calcination at a temperature of 650° C. (J. van den Broek, S. Afyon and J. L. M. Rupp, Adv. Energy Mater., 2016, 6, 1600736).

For the synthesis of cubic garnet particles of the composition c-Li_{6.25}Al_{0.25}La₃Zr₂O₁₂, stoichiometric amounts of LiNO₃, Al(NO₃)₃·9H₂O, La(NO₃)₃·6(H₂O), and zirconium (IV) acetylacetonate were dissolved in a water/ethanol mixture at temperatures of 70° C. To avoid possible Li-loss during calcination and sintering, the lithium precursor was taken in a slight excess of 10 wt % relative to the other precursors. The solvent was left to evaporate overnight at 95° C. to obtain a dry xerogel, which was ground in a mortar and calcined in a vertical tube furnace at 650° C. for 15 h in alumina crucibles under a constant synthetic airflow. Calcination directly yielded the cubic phase c-Li_{6.25}Al_{0.25}La₃Zr₂O₁₂, which was ground to a fine powder in a mortar for further processing.

The c-Li_{6.25}Al_{0.25}La₃Zr₂O₁₂ solid electrolyte pellets with relative densities of ˜87±3% made from this powder (sintered in a horizontal tube furnace at 1070° C. for 10 h under O₂ atmosphere) exhibited an ionic conductivity of ˜0.5×10⁻³ S cm⁻¹ (RT). The garnet-type solid electrolyte with a composition of c-Li₆₂₅Al_{0.25}La₃Zr₂O₁₂ (LLZO) in a powder form was encapsulated in several ion-conducting polymers.

### Example 4: Preparation of Sodium Superionic Conductor(NASICON) Type. Inorganic Solid Electrolyte Powder

The Na_{3.1}Zn_{1.95}M_{0.05}Si₂PO₁₂ (M=Mg, Ca, Sr, Ba) materials were synthesized by doping with alkaline earth ions at octahedral 6-coordination Zr sites. The procedure employed consists of two sequential steps. Firstly, solid solutions of alkaline earth metal oxides (MO) and ZrO₂ were synthesized by high energy ball milling at 875 rpm for 2 h. Then NASICON Na_{3.1}Zr_{1.95}M_{0.05}Si₂PO₁₂ structures were synthesized through solid-state reaction of Na_{2.0}O₃, Zr_{1.95}M_{0.05}O_{3.95}, SiO₂, and NH₄H₂PO₄ at 1260° C.

### Example 5: Production of PEDOT:PSS-Encapsulated ISE Particulates

Poly(3,4-ethylenedioxythiophene):polystyrene sulfonate (PEDOT:PSS) is a polymer mixture of two ionomers. One component is made up of sodium polystyrene sulfonate, which is a sulfonated polystyrene. Part of the sulfonyl groups are deprotonated and carry a negative charge. The other component poly(3,4-ethylenedioxythiophene) or PEDOT is a conjugated polymer, polythiophene, which carries positive charges. Together the two charged polymers form a macromolecular salt. The PEDOT/PSS is soluble in water and several organic solvents, such as hydrofluoroether solvents, ethylene glycol, and dimethyl sulfoxide (DMSO).

Desired amounts of the ISE particles (oxide prepared in Example 3) were then dispersed in a PEDOT/PSS-water solution to form a slurry (5% by wt. solid content), which was then spray-dried to form hybrid solid electrolyte particulates.

A lithium metal cell was made, comprising a lithium metal foil as the anode active material, a cathode (comprising 75% by weight of LiCoO₂ as the cathode active material, 15% of hybrid particulates, 5% PVDF binder, and 5% combined graphene/CNT as a conductive additive), and a solid-state electrolyte-based separator composed of particles of Li₇La₃Zr₂O₁₂ embedded in a poly(vinylidene fluoride)-hexafluoropropylene (PVDF-HFP) matrix (inorganic solid electrolyte/PVDF-HFP ratio=4/6).

### Example 6: Preparation of Polypyrrole-Encapsulated ISE Particulates

Polypyrrole networks (cross-linked PPy) were prepared via a two-reactant, one-pot process. Pyrrole (>97% purity) was dissolved in a solvent of water/ethanol (1:1 by weight) to achieve the first reactant having a concentration of 0.209 mol/L.

Then, as the second reactant, aqueous solutions of ferric nitrate (Fe(NO₃)₃·9H₂O) and ferric sulphate, respectively, were made at concentrations of 0.5 mol/L. Subsequently, polymerization of the network was carried out in an ice bath at 0° C., by mixing volumes of the two reactants at 1:1 molar ratios of pyrrole:ferric salt, to create a reacting mixture with a total of 4 mL. A desired amount of ISE particles (those prepared in Examples 1, 3, and 4, respectively) was dispersed in this reacting mixture. After rigorously stirring for 1 minutes, the slurry mass was allowed to stand and polymerization and gelation began after 5 minutes. A pyrrole:ferric salt molar ratio of 1:1, which is stoichiometrically deficient of ferric salt, leads to secondary growth (cross-linking) of the polypyrrole network; the reaction was allowed to proceed for 0.5-3 days to form a slightly viscous slurry. The slurry was then spray-dried to form micro-droplets. The encapsulating conducting polymer mass was allowed to continue for additional 1-20 days to complete the reaction.

For water-sensitive inorganic solid electrolytes (e.g., sulfide-type), water-free organic solvents were used. For instance, the doped PPy could be dissolved in polar solvents, such as chloroform, dimethyl sulfoxide (DMSO), m-cresol, N-Methyl-2-pyrrolidone (NMP), and tetrahydrofuran (THF). Actually, PPy could be synthesized directly in an organic solvent. For instance, PPy soluble in chloroform and m-cresol was chemically synthesized by using ammonium persulfate as an oxidant and dodecylbenzene sulfonic acid as a dopant source. Electrical conductivity of resulting PPy becomes higher when polymerized, with higher concentration of the oxidant and at lower polymerization temperature. The surface of PPy film cast from the solution shows an electrical conductivity of 4.5 S/cm.

### Example 7: Polyaniline-Encapsulated ISE Particulates

The precursor of a conducting network polymer, such as cross-linkable polyaniline and polypyrrole, may contain a monomer, an initiator or catalyst, a crosslinking agent, an oxidizer and/or dopant. As an example, 3.6 ml aqueous solution A, which contains 400 mM aniline monomer and 120 mM phytic acid, was added and mixed with a desired weight of ISE particles. Subsequently, 1.2 ml solution B, containing 500 mM ammonium persulfate was added into the above mixture and subjected to bath sonication for 1 min. The resulting reactive suspension was coated onto a stainless steel foil surface. In about 5 min, the solution changed color from brown to dark green and became viscous and gel-like, indicating in-situ polymerization of aniline monomer to form the PANi hydrogel. The gel was sprayed over a glass surface to form a porous film. The film was cured at 50° C. for 2 hours to obtain a PANi network polymer-encapsulated ISE particulates. Air jet mill was used to break up the solid film to produce hybrid solid electrolyte particulates.

Since certain solid electrolytes (e.g., sulfide-type) are sensitive to water, other types of organic solvents can be used. For instance, m-Cresol (3-methylphenol) has the solubility of PANi within the range 2-10 (% w/w) and could lead to a PANi conductivity of around 300 S/cm. Methanol, acetone, ethanol, N-methyl-2-pyrrolidone (NMP), DMF, dimethyl sulphoxide (DMSO) and THF are also suitable solvents for Polyaniline Emeraldine Base (PANI-EB). The PANI salt showed good solubility in common solvents, such as chloroform, and in a 1:3 mixtures by volume of 2-propanol and toluene.

In an example, 0.47 g (0.1M) of aniline was dissolved in hydrochloride solution (1M). Then the organic solvent (DMF, DMSO and THF, respectively) was dropped into the above solution under stirring. Approximately 5 min later, (0.1M) ammonium persulfate (APS) dissolved in 50 ml of hydrochloride solution (1M) was added into the mixture in a dropwise manner to initiate the polymerization of the aniline. Selected ISE particles (e.g., those prepared in Example 2) were quickly added into the reacting mass. The mixture was stirred at room temperature for 8 h and the resulting precipitate was collected by filtration. After the product was washed by distilled water and ethanol continuously, the product was dried under vacuum at room temperature for 48 h.

### Example 8: Heparin-Based Material as a Curing Agent for the Preparation of a Conducting Polymer Network that Encapsulates ISE Particles

The conducting polymer may be produced from a monomer using heparin-based crosslinking agent (e.g., in addition to phytic acid). Aqueous solutions of heparin (0.210% w/w) were prepared using 5M NaOH. Photo-cross-linkable heparin methacrylate (Hep-MA) precursors were prepared by combining heparin (porcine source, Mw ˜1719 kDa) incubated with methacrylic anhydride (MA) and adjusted to pH=8. The degree of substitution (DS) of methacrylate groups covalently linked to heparin precursors was measured by 1H nuclear magnetic resonance. The DS was determined from integral ratios of peaks of the methacrylate groups at 6.2 ppm compared to peak corresponding to methyl groups in heparin at 2.05 ppm.

Solutions used for photopolymerization were incubated with 2-methyl-1-[4-(hydeoxyethoxy)phenyl]-2-methyl-1-propanone (Irgacure 2959) to create final concentrations of 0.5% (w/w) of photoinitiator. Gels were photo-cross-linked using UV illumination for 30-60 min (λmax=365 nm, 10 mW/cm²). Hep-MA/PANI dual-networks were formed by sequentially incubating cross-linked Hep-MA hydrogels in aqueous solutions of ANI ([ANI]₀, between 0.1 and 2 M, 10 min) and acidic solutions of APS ([APS]₀, between 12.5 mM and 2 M, 20120 min). The gel fraction of Hep-MA/PANI dual networks was recovered by washing in di H₂O after oxidative polymerization. Non-water-sensitive ISE particles could be added into the reacting mass during various stages of reactions before droplet formation.

The lithium-ion cells prepared in this example comprise an anode of graphene-protected Si particles, a cathode of NCM-622 particles, conducting PANi-encapsulated ISE particles (mixed in the anode and the cathode), and a porous PE/PP membrane as a separator.

1. A hybrid solid electrolyte particulate for use in a rechargeable lithium battery cell, wherein said particulate comprises one or more than one inorganic solid electrolyte particles encapsulated by a shell of conducting polymer electrolyte wherein (i) the hybrid solid electrolyte particulate has a lithium-ion conductivity from 10⁻⁶ S/cm to 5×10⁻² S/cm and both the inorganic solid electrolyte and the conducting polymer electrolyte individually have a lithium-ion conductivity no less than 10⁻⁶ S/cm; (ii) the conducting polymer electrolyte has an electron conductivity no less than 10⁻⁶ S/cm; and (iii) the conducting polymer electrolyte-to-inorganic solid electrolyte ratio is from 1/100 to 100/1 or the conducting polymer electrolyte shell has a thickness from 1 nm to 10 μm.

2. The hybrid solid electrolyte particulate of claim 1, wherein the inorganic solid electrolyte material is selected from an oxide type, sulfide type, hydride type, halide type, borate type, phosphate type, lithium phosphorus oxynitride (LIPON), garnet-type, lithium superionic conductor (LISICON) type, sodium superionic conductor (NASICON) type, or a combination thereof.

3. The hybrid solid electrolyte particulate of claim 1, wherein the conducting polymer electrolyte comprises a linear, branched, or network of crosslinked chains comprising chains of a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly [(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

4. The hybrid solid electrolyte particulate of claim 1, wherein the conducting polymer comprises a network of crosslinked chains comprising polyaniline, polypyrrole, or polythiophene chains.

5. The hybrid solid electrolyte particulate of claim 1, wherein the conducting polymer comprises a network of crosslinked chains comprising chains of a conjugate polymer and chains selected from polyethylene oxide, polypropylene oxide, pentaerythritol tetraacrylate, poly(ethylene glycol) diacrylate, poly(ethylene glycol) methyl ether acrylate, poly(ethylene glycol phenyl ether acrylate) (PEGPEA), ethoxylated trimethyl propyl triacrylate (ETPTA), or a combination thereof.

6. The hybrid solid electrolyte particulate of claim 3, wherein the conducting polymer electrolyte further comprises a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, poly(alkylsiloxane), poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyacrylamide, a polyionic liquid, polymerized 1,3-dioxolane, polyepoxide ether, polysiloxane, poly(dimethyl siloxane), poly(alkyl siloxane), poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), chains of ethylene glycol phenyl ether acrylate) (PEGPEA) or ethoxylated trimethyl propyl triacrylate (ETPTA), poly(phosphate), poly(phosphonate), poly(phosphinate), poly(phosphine), poly(phosphine oxide), poly(phosphonic acid), poly(phosphorous acid), poly(phosphite), poly(phosphoric acid), poly(phosphazene) a chemical derivative thereof, a copolymer thereof, a sulfonated derivative thereof, or a combination thereof, wherein said ion-conducting polymer and the conjugate polymer form a polymer blend, a copolymer, a crosslinked network of chains, a semi-interpenetrating network, or a simultaneous interpenetrating network.

7. The rechargeable lithium cell of claim 1, wherein the conducting polymer electrolyte further comprises 0.1%-60% by weight of a lithium salt dispersed therein.

8. The hybrid solid electrolyte particulate of claim 7, wherein the lithium salt is selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂₀₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4, or a combination thereof.

9. A rechargeable lithium cell comprising an anode, a cathode, and a separator disposed between the anode and the cathode, wherein at least one of the anode and the cathode comprises multiple hybrid solid electrolyte particulates as defined in claim 1.

10. The rechargeable lithium cell of claim 9, wherein:
the hybrid solid electrolyte particulates comprise a 1^{st} conducting polymer electrolyte encapsulating inorganic solid electrolyte particles;
the anode comprises multiple anode particulates comprising anode active material particles encapsulated by a 2^{nd} conducting polymer electrolyte, wherein the 1^{st} conducting polymer electrolyte and the 2^{nd} conducting polymer electrolyte are identical or different in chemical composition or structure; and
the hybrid solid electrolyte particulates and the anode particulates are compacted or consolidated to form the anode.

11. The rechargeable lithium cell of claim 10, further including a conductive additive that is compacted or consolidated with said hybrid solid electrolyte particulates and said anode particulates to form said anode.

12. The rechargeable lithium cell of claim 9, wherein:
the hybrid solid electrolyte particulates comprise a 1^{st} conducting polymer electrolyte encapsulating inorganic solid electrolyte particles;
the cathode comprises multiple cathode particulates each comprising cathode active material particles encapsulated by a 2^{nd} conducting polymer electrolyte or a layer of carbon, wherein the 1^{st} conducting polymer electrolyte and the 2^{nd} conducting polymer electrolyte are identical or different in chemical composition or structure; and
the hybrid solid electrolyte particulates and the cathode particulates are compacted or consolidated to form the cathode.

13. The rechargeable lithium cell of claim 12, further including a conductive additive that is compacted or consolidated with said hybrid solid electrolyte particulates and said cathode particulates to form said cathode.

14. The rechargeable lithium cell of claim 9, wherein the cathode comprises a cathode active material selected from lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

15. The rechargeable lithium cell of claim 9, which is a lithium-ion cell wherein the anode comprises an anode active material selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

16. The rechargeable lithium cell of claim 9, which is a lithium metal secondary cell, a lithium-ion cell, a lithium-sulfur cell, a lithium-ion sulfur cell, a lithium-selenium cell, or a lithium-air cell.

17. A powder product comprising multiple hybrid solid electrolyte particulates as defined in claim 1.

18. An anode comprising a mixture of multiple anode active material particles and multiple hybrid solid electrolyte particulates as defined in claim 1.

19. The anode of claim 18, wherein the multiple hybrid solid electrolyte particulates each comprising one or a plurality of the inorganic solid electrolyte particles encapsulated by a 1^{st} conducting polymer electrolyte and wherein the anode comprises multiple anode particulates each comprising one or a plurality of the anode active material particles encapsulated by a 2^{nd} conducting polymer electrolyte, wherein the 1^{st} conducting polymer electrolyte and the 2^{nd} conducting polymer electrolyte are identical or different in chemical composition or structure.

20. A cathode comprising a mixture of multiple cathode active material particles and multiple hybrid solid electrolyte particulates as defined in claim 1.

21. The cathode of claim 20, wherein the multiple hybrid solid electrolyte particulates each comprising one or a plurality of the inorganic solid electrolyte particles encapsulated by a 1^{st} conducting polymer electrolyte and wherein the cathode comprises multiple cathode particulates each comprising one or a plurality of the cathode active material particles encapsulated by a 2^{nd} conducting polymer electrolyte, wherein the 1^{st} conducting polymer electrolyte and the 2^{nd} conducting polymer electrolyte are identical or different in chemical composition or structure.

22. A process for producing a plurality of the hybrid solid electrolyte particulates as defined in claim 1, said process comprising:
(A) dispersing a plurality of primary particles of an inorganic solid electrolyte, having a diameter or thickness from 1 nm to 20 μm, in a reactive liquid mixture of (i) a monomer, oligomer, or cross-linkable polymer as a precursor to the conducting polymer and (ii) an initiator and/or a cross-linking agent to form a reactive slurry;
(B) forming the reactive slurry into micro-droplets; and
(C) polymerizing and/or curing the monomer, the oligomer or the cross-linkable polymer in said micro-droplets to form the hybrid solid electrolyte particulates.

23. The process of claim 22, wherein said step (B) of forming micro-droplets comprises a procedure selected from pan-coating, air-suspension coating, centrifugal extrusion, vibration-nozzle encapsulation, spray-drying, kneadering, casting and drying, coacervation-phase separation, interfacial polycondensation or interfacial cross-linking, in-situ polymerization, matrix polymerization, extrusion and palletization, or a combination thereof.

24. The process of claim 22, wherein said micro-droplets contain water or a liquid solvent and the process further comprises a step of removing said water or solvent.

25. The process of claim 22, further comprising a step of combining said hybrid solid electrolyte particulates and particles of an anode active material into an anode electrode; or combining said hybrid solid electrolyte particulates, particles of a cathode active material into a cathode electrode.

26. The process of claim 25, further including a conductive additive that is compacted or consolidated with said hybrid solid electrolyte particulates and said anode particulates to form said anode or that is compacted or consolidated with said hybrid solid electrolyte particulates and said cathode particulates to form said cathode.

27. A process for producing a plurality of the hybrid solid electrolyte particulates as defined in claim 1, said process comprising:
a) dispersing a plurality of primary particles of an inorganic solid electrolyte, having a diameter or thickness from 1 nm to 20 μm, in a liquid solution, comprising a conducting polymer dispersed or dissolved in a liquid solvent, to form a slurry;
b) forming the slurry into micro-droplets; and
c) removing the liquid solvent in said micro-droplets to form the hybrid solid electrolyte particulates.

28. The process of claim 27, wherein said step (B) of forming micro-droplets comprises a procedure selected from pan-coating, air-suspension coating, centrifugal extrusion, vibration-nozzle encapsulation, spray-drying, extrusion and palletization, kneadering, or a combination thereof.

29. The process of claim 22, further comprising a step of combining and consolidating (i) said hybrid solid electrolyte particulates having a 1^{st} conducting polymer electrolyte encapsulating inorganic solid electrolyte particles and (ii) anode or cathode active material particles encapsulated by a 2^{nd} conducting polymer electrolyte to form an anode or cathode electrode, wherein the 1^{st} conducting polymer electrolyte and the 2^{nd} conducting polymer electrolyte are identical or different in chemical composition or structure.

30. The process of claim 29, further including a conductive additive that is also encapsulated with said anode or cathode active material particles to form said anode or cathode electrode.

31. The process of claim 28, further comprising a step of combining and consolidating (i) said hybrid solid electrolyte particulates having a 1^{st} conducting polymer electrolyte encapsulating inorganic solid electrolyte particles and (ii) anode or cathode active material particles encapsulated by a 2^{nd} conducting polymer electrolyte to form an anode or cathode electrode, wherein the 1^{st} conducting polymer electrolyte and the 2^{nd} conducting polymer electrolyte are identical or different in chemical composition or structure.

32. The process of claim 31, further including a conductive additive that is also encapsulated with said anode or cathode active material particles to form said anode or cathode electrode.

33. The process of claim 27, wherein the liquid solvent is elected from tetrahydrofuran, dimethyl sulfoxide, butyrolactone, dimethylacetamide, dimethylformamide, dimethyl sulfite, methyl acetate, methyl formate, nitromethane, propylene carbonate, chloro-pentafluoro benzene, methyl tetrahydrofuran, thiophene, dimethyl carbonate, pyridine, sulfolane, or a mixture thereof.
